(19) United States
(12) Patent Application Publication
(10) Pub. No.: US 2013/0168592 A1
(43) Pub. Date: Jul. 4, 2013

(54) Diaphragm Valve

(71) Applicant: Hong YAN, Xiamen City (CN)

(72) Inventor: Hong YAN, Xiamen City (CN)

(21) Appl. No.: 13/340,370

(22) Filed: Dec. 29, 2011

(51) Int. Cl. F16K 7/00

(52) U.S. Cl. 251/331

(57) ABSTRACT

The diaphragm valve includes an outer casing, a winding stand, a magnetizable valve core, a nozzle, a rubber diaphragm, a bottom seat, a bottom board, a spring, a rear lid and a copper pin. The rubber diaphragm is fixed at the front end of the valve core, and has a circumferential edge to communicate with the center of the rubber diaphragm through a resilient protruding ring. The nozzle has a flange, a radial hole and an eccentric axial hole. The nozzle is fixed at the front end of the winding stand by the flange. The flange has a stepped hole to mate with the circumferential edge of the rubber diaphragm, a central hole to mate with the center of the rubber diaphragm, and an eccentric hole. The stepped hole communicates with the radial hole through the central hole and communicates with the axial hole through the eccentric hole.

### BACKGROUND OF THE INVENTION

1. Field of the Invention

The present invention relates to a diaphragm valve adapted for vehicles, medical apparatuses, electric appliances and the like.

2. Description of the Prior Art

As shown in FIG. 1, a solenoid valve for household appliances or vehicular accessories comprises an outer casing 10, a winding stand 20, a valve core 30, a rubber block nozzle 40, a bottom seat 50 with a seal ring 51, a spring 60, a rear lid 70, a rubber pad 80, a gasket 90, and a copper pin 100. The rubber block nozzle 40 is fixed in the front end of the valve core 30. The valve core 30, the spring 60 and the bottom seat 50 are assembled in a central pipe of the winding stand 20. The gasket 90 is mounted at the front end of the winding stand 20. The rear lid 70 and the rubber pad 80 are mounted at the rear end of the winding stand 20. The outer casing 10 is fitted and riveted on the winding stand 20 having copper wires. The copper pin 100 is mounted on the rubber pad 80 and connected with the copper wires.

When the solenoid valve is in use and does not electrify, by push of the spring 60, the valve core 30 brings the rubber nozzle 40 to move forward to block the axial hole of the winding stand 20. The solenoid valve is in a closed state. When electrified, the copper coil on the winding stand 20 generates a magnetic field to magnetize the valve core 30 and the bottom seat 50. The valve core 30 and the bottom seat 50 are attracted each other by magnetism to compress the spring 60. The valve core 30 brings the rubber block nozzle 40 to move rearward and to open the axial hole of the winding stand 20, so that the axial hole of the winding stand 20 communicates with the radial hole. The solenoid valve is in an open state. After cutting off the power supply, the valve core 30 is biased by the spring 60 to bring the rubber block nozzle 40 to block the axial hole of the winding stand 20 again. The solenoid valve is in a closed state.

The outer surface of the rubber block nozzle 40 is a conical surface. The solenoid valve uses the conical surface of the rubber block nozzle 40 to mate with the axial hole of the winding stand 20 so as to open and close the solenoid valve. The radial hole is opened all along. If the medium is corrosive, the parts will be corroded to influence the seal effect. Sometimes, the solenoid valve may malfunction. This solenoid valve doesn't have a better seal effect and may be corroded by the medium. Accordingly, the inventor of the present invention has devoted himself based on his many years of practical experiences to solve these problems.

### SUMMARY OF THE INVENTION

The primary object of the present invention is to provide a diaphragm valve which has a better seal effect and can prevent corrosion by the medium.

In order to achieve the aforesaid object, the diaphragm valve of the present invention comprises an outer casing, a winding stand, a magnetizable valve core, a nozzle, a rubber diaphragm, a bottom seat, a bottom board, a spring, a rear lid and a copper pin. The outer casing is fitted and riveted on the winding stand having copper wires. The bottom board is disposed at a rear end of the winding stand. The rear lid is fixed at the rear end of the winding stand. One end of the copper pin is connected with the winding stand, and another end of the copper pin extends out of the rear lid and connects with a power source. The magnetizable valve core, the spring and the bottom seat are disposed in a central pipe of the winding stand. The rubber diaphragm is fixed at a front end of the valve core. The rubber diaphragm has a circumferential edge to communicate with the center of the rubber diaphragm through a resilient protruding ring. The nozzle has a flange, a radial hole and an eccentric axial hole. The nozzle is fixed at a front end of the winding stand by means of the flange. The flange has a stepped hole to mate with the circumferential edge of the rubber diaphragm, a central hole to mate with the center of the rubber diaphragm, and an eccentric hole. The stepped hole communicates with the radial hole through the central hole and communicates with the axial hole through the eccentric hole.

Preferably, the valve has a central axial post. The rubber diaphragm has a central axial sleeve for connection of the axial post.

Preferably, the center of the rubber diaphragm is formed with a block head to extend in the stepped hole and to mate with the central hole.

Preferably, the circumferential edge of the rubber diaphragm is formed with a reinforcement wall.

Preferably, the axial hole and the eccentric axial hole are provided with a nozzle cover.

Preferably, the bottom board is integrally formed with the rear lid.

After the present invention is assembled, the circumferential edge of the rubber diaphragm tightly seals the stepped hole of the nozzle all along, preventing corrosion by the medium. When the solenoid valve is in use and does not electrify, by push of the spring, the valve core brings the rubber diaphragm to move forward with the center of the rubber diaphragm to block the central hole of the nozzle and to close the axial hole. The solenoid valve is in a closed state. When electrified, the copper coil on the winding stand generates a magnetic field to magnetize the valve core and the bottom seat. The valve core and the bottom seat are attracted each other by magnetism to compress the spring. The valve core brings the center of the rubber diaphragm to move rearward and to open the central hole of the nozzle, so that the radial hole of the nozzle communicates with the axial hole through the central hole and the central hole. The solenoid valve is in an open state. At this time, the circumferential edge of the rubber diaphragm still seals the stepped hole of the nozzle, preventing corrosion by the medium. After cutting off the power supply, the valve core is biased by the spring to bring the center of the rubber diaphragm to block the central hole of the nozzle again. The solenoid valve is in a closed state.

Compared to the prior art, the rubber diaphragm is instead of the rubber block nozzle. The circumferential edge of the rubber diaphragm is to seal the stepped hole after assembled, preventing the medium from entering the valve. The present provides a better seal effect and can prevent corrosion by the medium.

### BRIEF DESCRIPTION OF THE DRAWINGS

FIG. 1 is a sectional view of an air conventional valve;

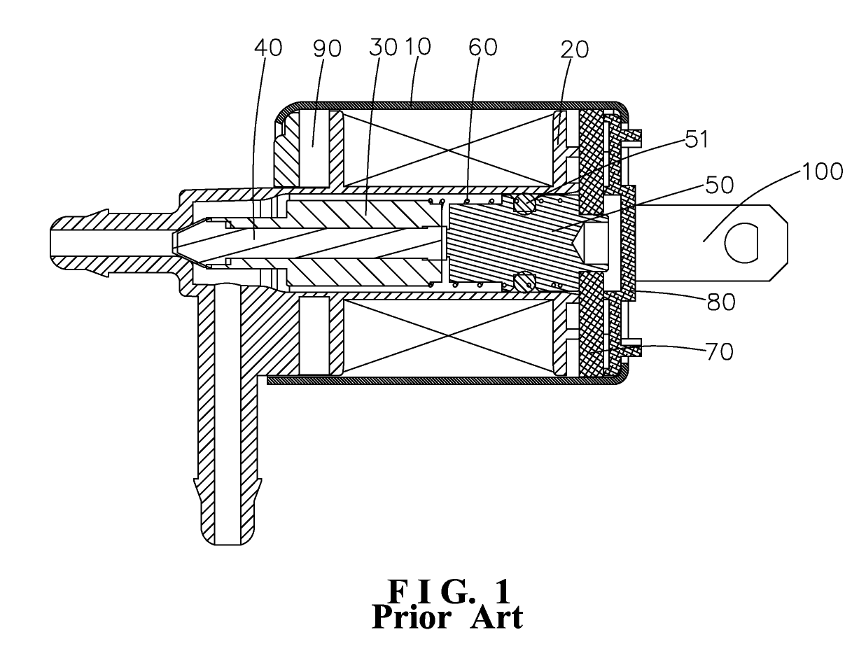

FIG. 2 is an exploded view according to a preferred embodiment of the present invention;

FIG. 3 is a sectional view of the preferred embodiment of the present invention in an open state;

FIG. 4 is a sectional view of the preferred embodiment of the present invention in a closed state;

FIG. 5 is a sectional view showing the rubber diaphragm according to the preferred embodiment of the present invention;

FIG. 6 is a sectional view showing the nozzle according to the preferred embodiment of the present invention; and

FIG. 7 is a side view showing the nozzle according to the preferred embodiment of the present invention.

### DETAILED DESCRIPTION OF THE PREFERRED EMBODIMENTS

Embodiments of the present invention will now be described, by way of example only, with reference to the accompanying drawings.

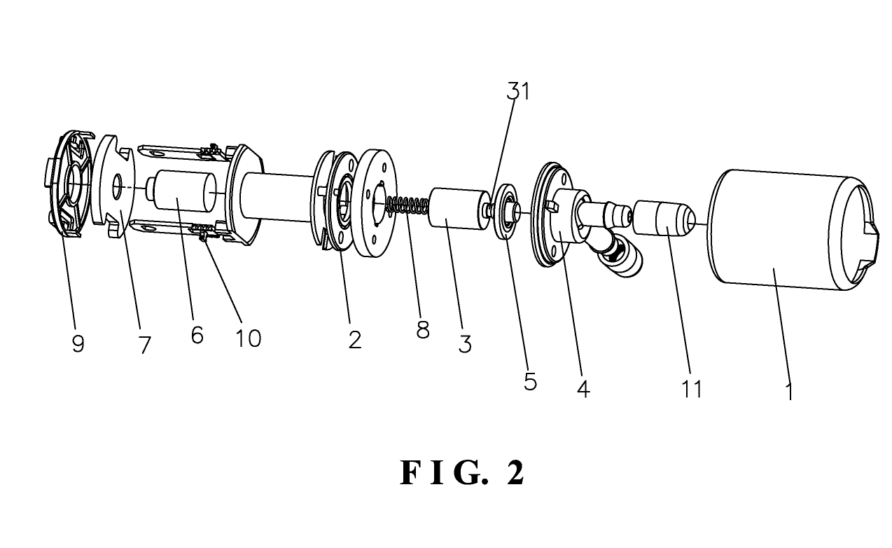

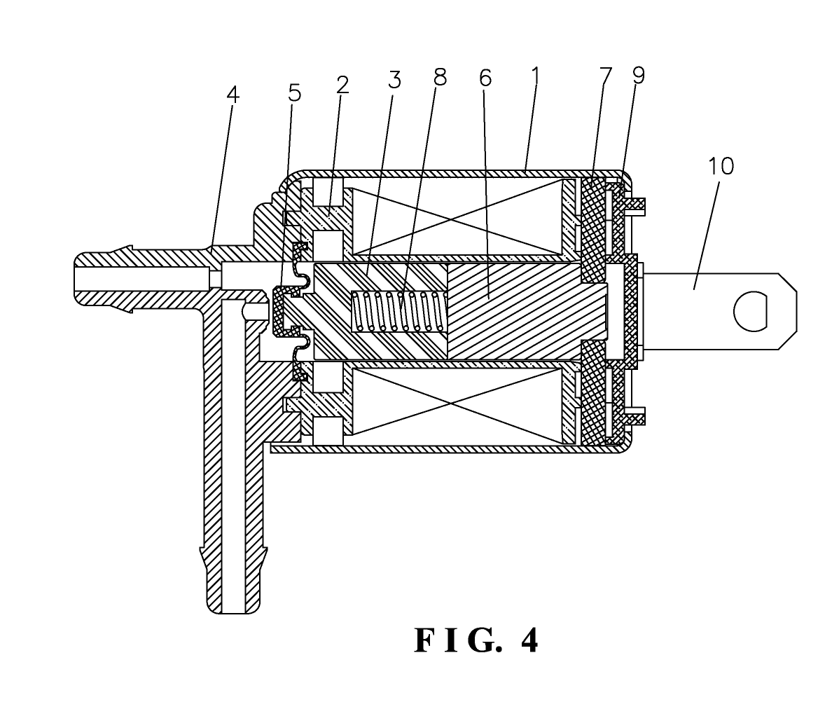

As shown in FIG. 2 and FIG. 4, the diaphragm valve according to a preferred embodiment of the present invention comprises an outer casing 1, a winding stand 2, a magnetizable valve core 3, a nozzle 4, a rubber diaphragm 5, a bottom seat 6, a bottom board 7, a spring 8, a rear lid 9, and a copper pin 10.

The outer casing 1 is fitted and riveted on the winding stand 2 having copper wires.

The bottom board 7 is disposed at a rear end of the winding stand 2. The rear lid 9 is fixed at the rear end of the winding stand 2. The bottom board 7 may be integrally formed with the rear lid 9.

One end of the copper pin 10 is connected with the winding stand 2, and another end of the copper pin 10 extends out of the rear lid 9 and connects with a power source.

The magnetizable valve core 3, the spring 8 and the bottom seat 6 are disposed in a central pipe of the winding stand 2. Two end of the spring 8 are against the valve core 3 and the bottom seat 6, respectively.

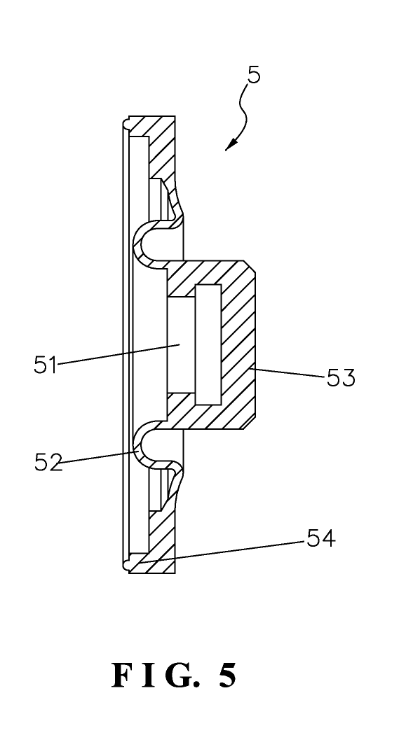

The rubber diaphragm 5 is fixed at a front end of the valve core 3. As shown in FIG. 5, the valve 3 of this embodiment has a central axial post 31. The rubber diaphragm 5 has a central axial sleeve 51 for connection of the axial post 31. The rubber diaphragm 5 has a circumferential edge to communicate with the center of the rubber diaphragm 5 through a resilient protruding ring 52, so that the rubber diaphragm 5 can be deformed when a force is applied to the rubber diaphragm 5 with the circumferential edge and the center of the rubber diaphragm 5 to provide a better seal effect.

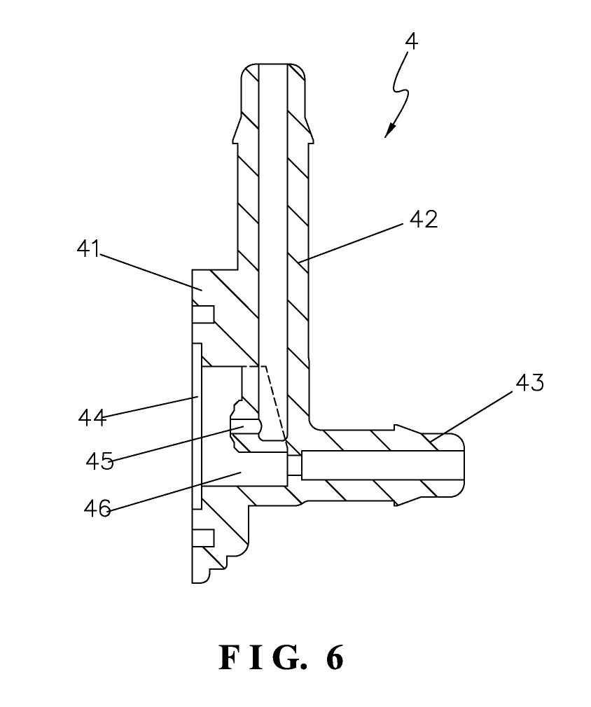

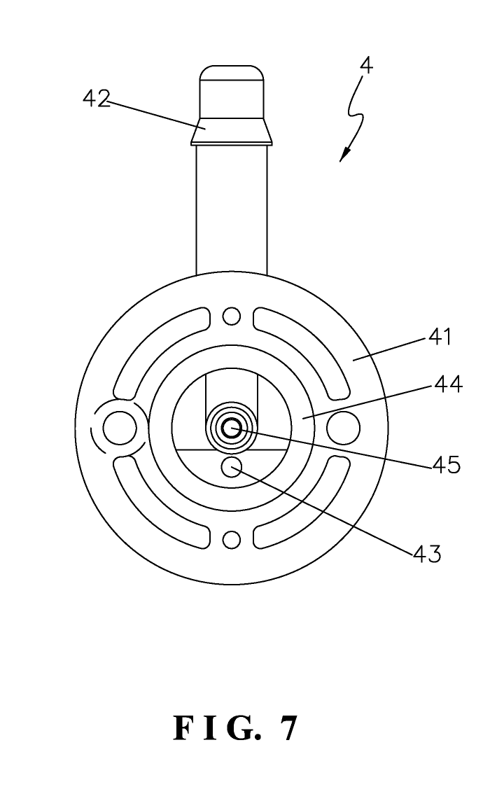

As shown in FIG. 6 and FIG. 7, the nozzle 4 has a flange 41, a radial hole 42, and an eccentric axial hole 43. The nozzle 4 is fixed at a front end of the winding stand 2 by means of the flange 41. The flange 41 has a stepped hole 44, a central hole 45, and an eccentric hole 46. The stepped hole 44 communicates with the radial hole 42 through the central hole 45, and communicates with the axial hole 43 through the eccentric hole 46. The circumferential edge of the rubber diaphragm 5 is to seal the stepped hole 44 after assembled, preventing the medium from entering the valve. In this embodiment, the circumferential edge of the rubber diaphragm 5 is formed with a reinforcement wall 54, such that the circumferential edge of the rubber diaphragm 5 can tightly seal the stepped hole 44 to prevent the medium from entering the valve. The valve core 3 brings the center of the rubber diaphragm 5 to mate with the central hole 45 for the valve to be opened or closed. In this embodiment, the center of the rubber diaphragm 5 is formed with a block head 53 to extend in the stepped hole 44 and to mate with the central hole 45, so that the center of the rubber diaphragm 5 can open or close the central hole 45 exactly.

Furthermore, the axial hole 42 and the eccentric axial hole 43 are provided with a nozzle cover 11.

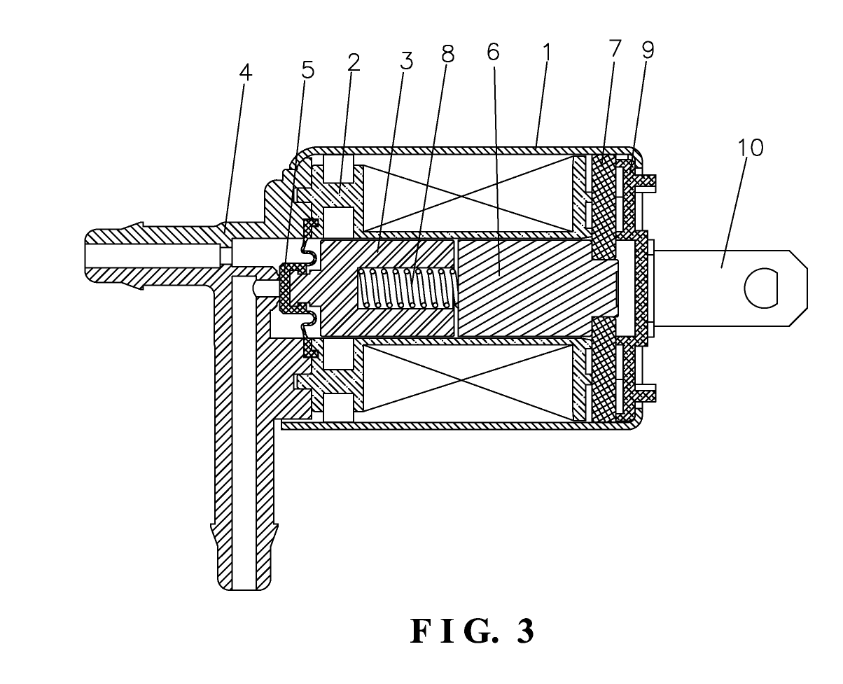

As shown in FIG. 3 and FIG. 4, after the present invention is assembled, the circumferential edge of the rubber diaphragm 5 tightly seals the stepped hole 44 of the nozzle 4 all along, preventing corrosion by the medium.

As shown in FIG. 3, when the solenoid valve is in use and does not electrify, by push of the spring 8, the valve core 3 brings the rubber diaphragm 5 to move forward with the center of the rubber diaphragm 5 to block the central hole 45 of the nozzle 4 and to close the axial hole 42. The solenoid valve is in a closed state.

As shown FIG. 4, when electrified, the copper coil on the winding stand 2 generates a magnetic field to magnetize the valve core 3 and the bottom seat 6. The valve core 3 and the bottom seat 6 are attracted each other by magnetism to compress the spring 8. The valve core 3 brings the center of the rubber diaphragm 5 to move rearward and to open the central hole 45 of the nozzle 4, so that the radial hole 42 of the nozzle 4 communicates with the axial hole 43 through the central hole 45 and the central hole 46. The solenoid valve is in an open state. At this time, the circumferential edge of the rubber diaphragm 5 still seals the stepped hole 44 of the nozzle 4, preventing corrosion by the medium.

As shown in FIG. 3, after cutting off the power supply, the valve core 3 is biased by the spring 8 to bring the center of the rubber diaphragm 5 to block the central hole 45 of the nozzle 4 again. The solenoid valve is in a closed state.

Although particular embodiments of the present invention have been described in detail for purposes of illustration, various modifications and enhancements may be made without departing from the spirit and scope of the present invention.

Accordingly, the present invention is not to be limited except as by the appended claims.

What is claimed is:

1. A diaphragm valve, comprising an outer casing, a winding stand, a magnetizable valve core, a nozzle, a rubber diaphragm, a bottom seat, a bottom board, a spring, a rear lid and a copper pin; the outer casing being fitted and riveted on the winding stand having copper wires; the bottom board being disposed at a rear end of the winding stand; the rear lid being fixed at the rear end of the winding stand;
one end of the copper pin being connected with the winding stand, another end of the copper pin extending out of the rear lid and connecting with a power source; the magnetizable valve core, the spring and the bottom seat being disposed in a central pipe of the winding stand; the rubber diaphragm being fixed at a front end of the valve core, The rubber diaphragm having a circumferential edge to communicate with a center of the rubber diaphragm through a resilient protruding ring; the nozzle having a flange, a radial hole and an eccentric axial hole, the nozzle being fixed at a front end of the winding stand by means of the flange, the flange having a stepped hole to mate with the circumferential edge of the rubber diaphragm, a central hole to mate with the center of the rubber diaphragm, and an eccentric hole, the stepped hole communicating with the radial hole through the central hole and communicating with the axial hole through the eccentric hole.

2. The diaphragm valve as claimed in claim 1, wherein the valve has a central axial post, and the rubber diaphragm has a central axial sleeve for connection of the axial post.

3. The diaphragm valve as claimed in claim 1, wherein the center of the rubber diaphragm is formed with a block head to extend in the stepped hole and to mate with the central hole.

4. The diaphragm valve as claimed in claim 1, wherein the circumferential edge of the rubber diaphragm is formed with a reinforcement wall.

5. The diaphragm valve as claimed in claim 1, wherein the axial hole and the eccentric axial hole are provided with a nozzle cover.

6. The diaphragm valve as claimed in claim 1, wherein the bottom board is integrally formed with the rear lid.
